(19) United States
(12) Patent Application Publication
(10) Pub. No.: US 2021/0185462 A1
(43) Pub. Date: Jun. 17, 2021

(54) EAR TIP DESIGNS

(71) Applicant: Earlens Corporation, Menlo Park, CA (US)

(72) Inventors: Rodney C. PERKINS, Woodside, CA (US); Patricia H. HO, Redwood City, CA (US); Ketan MUNI, San Jose, CA (US); Jaime VASQUEZ, East Palo Alto, CA (US); Ryan LANE-LUTTER, Redwood City, CA (US); Paul RUCKER, San Francisco, CA (US); Jordan NEYSMITH, Dublin, CA (US)

(21) Appl. No.: 17/180,523

(22) Filed: Feb. 19, 2021

Related U.S. Application Data
(63) Continuation of application No. 16/866,866, filed on May 5, 2020.
Application No. 16/866,866 is a continuation of application No. 16/178,450, filed on Nov. 1, 2018, now abandoned.
(60) Provisional application No. 62/593,120, filed on Nov. 30, 2017.

(51) Int. Cl. H04R 25/00

(52) U.S. Cl. CPC H04R 25/652; H04R 2225/025; H04R 25/658

(57) ABSTRACT

An ear tip for use with a hearing aid is described, wherein the ear tip may include one or more features adapted to improve the comfort and or other characteristics of the ear tip.

### CROSS REFERENCE TO RELATED APPLICATIONS

The present application is a continuation of U.S. patent application Ser. No. 16/866,866, filed May 5, 2020; which is a continuation of U.S. patent application Ser. No. 16/178,450, filed Nov. 1, 2018; which claims priority to U.S. Provisional Patent Application No. 62/593,120, filed Nov. 30, 2017; the full disclosures of which are incorporated herein by reference.

### BACKGROUND OF THE INVENTIION

### Field of the Invention

The present invention is directed to improvements in devices for positioning components in the ear canal of a user and, more particularly, to ear tips used to position hearing aid components in the lateral end of a user's ear canal.

### Background

The present invention is intended to improve a number of the characteristics of ear tips. In particular, the inventions described are intended to improve characteristics such as: cerumen management; ear tip comfort; ear tip migration; and ease of insertion. In addition, the present invention may be used to improve ear tip stability during anatomical changes to the ear canal caused by, for example jaw movement and smiling. Further, the present invention may be used to improve alignment between, for example, a laser affixed to the ear tip and a photodetector positioned on the eardrum of a user.

### BRIEF DESCRIPTION OF THE DRAWINGS

The foregoing and other objects, features and advantages of embodiments of the present inventive concepts will be apparent from the more particular description of preferred embodiments, as illustrated in the accompanying drawings in which like reference characters refer to the same or like elements. The drawings are not necessarily to scale, emphasis instead being placed upon illustrating the principles of the preferred embodiments.

FIG. 1 is an illustration of an ear tip according to the present invention including multiple ear tip features.

FIG. 2 is an illustration of an ear tip according to the present invention including multiple ear tip features.

FIG. 3 is an illustration of an ear tip according to the present invention including multiple ear tip regions.

FIG. 4 is an illustration of an engagement feature according to the present invention.

FIG. 5 is an illustration of an engagement feature according to the present invention, wherein the engagement feature is in contact with the wall of an ear canal.

FIG. 6 is an illustration of the medial end of an ear tip including flutes according to the present invention.

FIG. 7 is an illustration of the medial end of an ear tip including flutes according to the present invention wherein the flutes have biological material, such as cerumen in them.

FIG. 8 is an illustration of the medial end of an ear tip including an alternative design for the flutes according to the present invention.

FIG. 9 is an illustration of the medial end of an ear tip including flutes according to the present invention wherein the flutes have varying lengths and widths.

FIGS. 10-14 are side cut away views of an ear tip including a modified central region according to the present invention.

FIG. 15 is an illustration of an ear tip according to the present invention wherein the ear tip has a stiff lateral end and a flexible medial end.

FIG. 16 is an illustration of an ear tip according to the present invention wherein the ear tip has a stiff superior edge and a flexible inferior edge.

FIG. 17 is an illustration of an ear tip according to the present invention wherein the ear tip has a diagonal rigidity transition.

FIG. 18 illustrates a processor and ear tip according to the present invention.

### DETAILED DESCRIPTION OF THE INVENTION

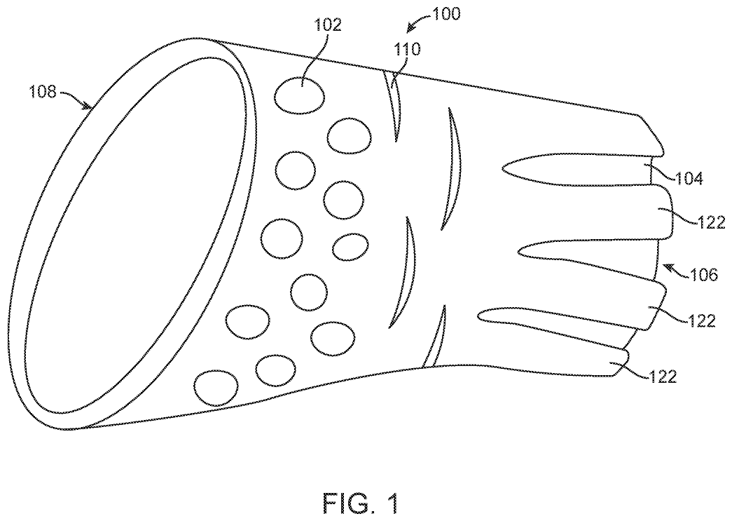

FIG. 1 is an illustration of an ear tip 100 according to the present invention wherein ear tip 100 includes multiple ear tip features. In the embodiment of FIG. 1, such ear tip features may include engagement features 102, flutes 104, and carve outs 110. In embodiments of the invention, engagement features 102 may be antiskid bumps or scales. In embodiments of the invention, ear tip 100 may include spines 122 separating flutes 104.

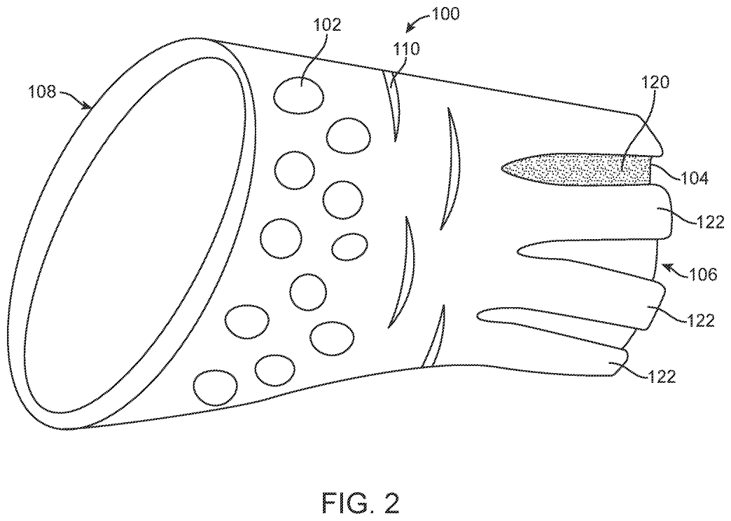

FIG. 2 is an illustration of an ear tip 100 according to the present invention including multiple ear tip features. In the embodiment of FIG. 2, flutes 104 may include micro-protrusions 104. In embodiments of the invention, micro-protrusions 104 may be micro-bumps.

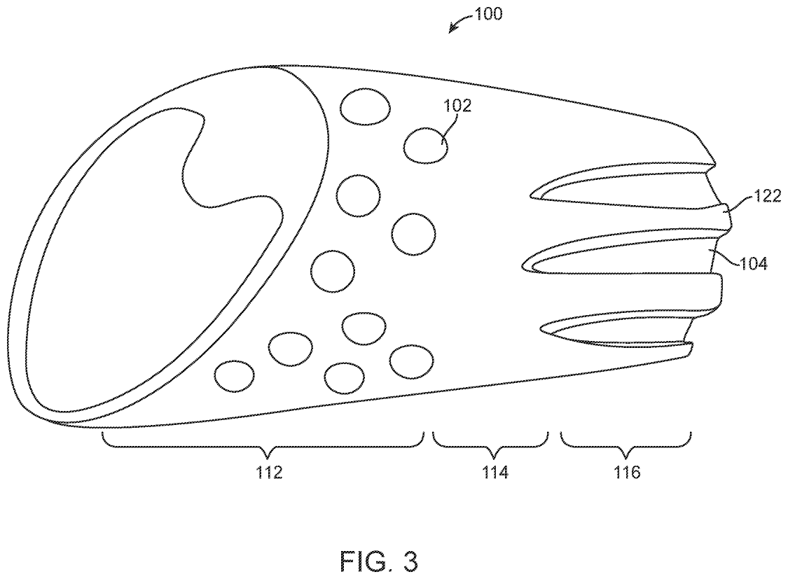

FIG. 3 is an illustration of an ear tip 100 according to the present invention including multiple ear tip regions. In embodiments of the invention, ear tip 100 may include a lateral region 112. In embodiments of the invention, lateral region 112 may be a retention feature region. In embodiments of the invention, ear tip 100 may include a central region 114. In embodiments of the invention, central region 114 may be a stability feature region. In embodiments of the invention, ear tip 100 may include a medial region 116. In embodiments of the invention, medial region 116 may be a comfort feature region.

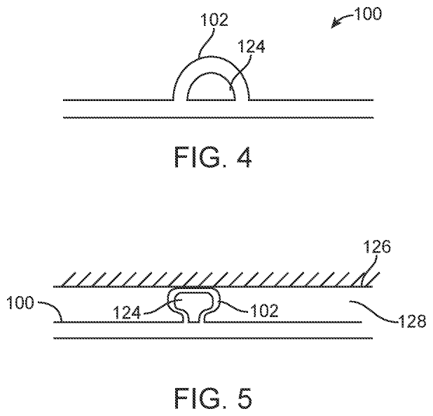

FIG. 4 is an illustration of an engagement feature 102 according to the present invention. In embodiments of the invention, engagement feature 102 may include a hollow region 124.

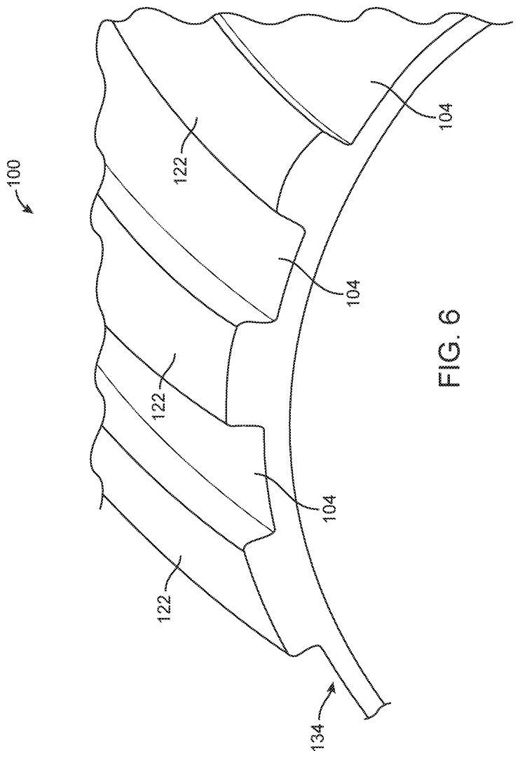

FIG. 5 is an illustration of an engagement feature102 according to the present invention, wherein the engagement feature is in contact with wall 126 of ear canal 128. In embodiments of the invention, engagement feature 102 deforms when ear tip 100 is in position in ear canal 128.

FIG. 6 is an illustration of medial end 134 of ear tip 100 including flutes 104 according to the present invention.

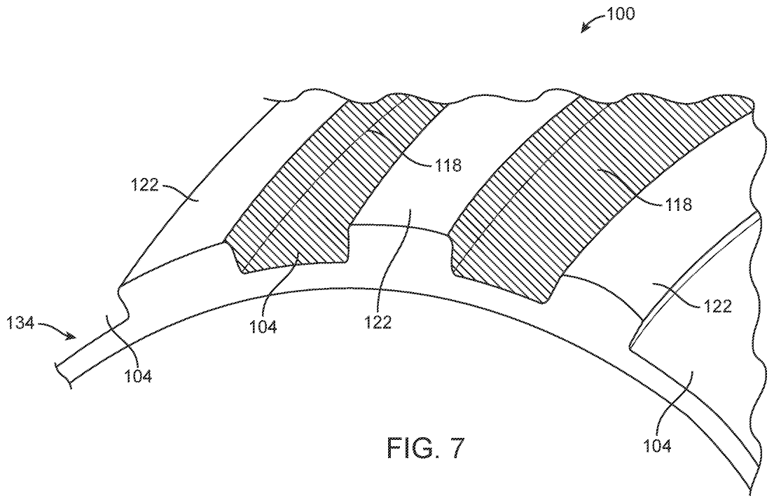

FIG. 7 is an illustration of medial end 134 of ear tip 100 including flutes 104 according to the present invention. As illustrated in FIG. 7, one or more of flutes 104 may have biological material 118 such as cerumen in them. In embodiments of the invention, flutes 104 may be designed to collect biological material 118 as ear tip 100 is inserted into the ear canal of a user.

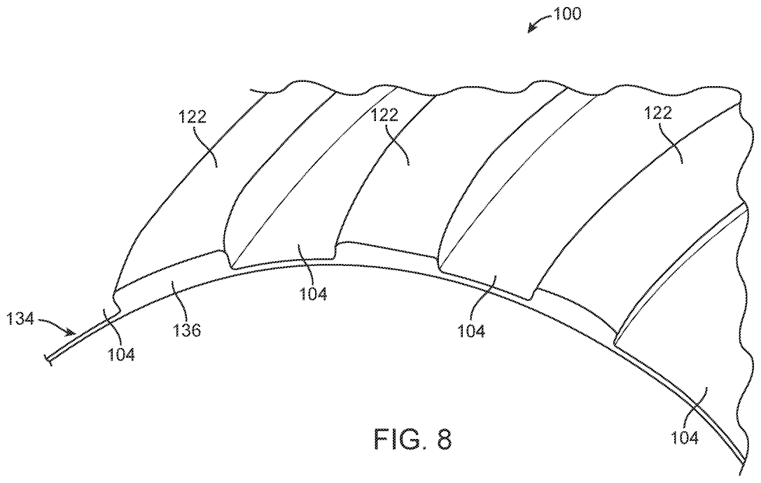

FIG. 8 is an illustration of the medial end of ear tip 100 including an alternative design for the flutes according to the present invention. In the embodiment of FIG. 8, flutes 104 are designed to have a thin leading edge 136. In embodiments of the invention, leading edge 136 facilitates the collection of biological material 118.

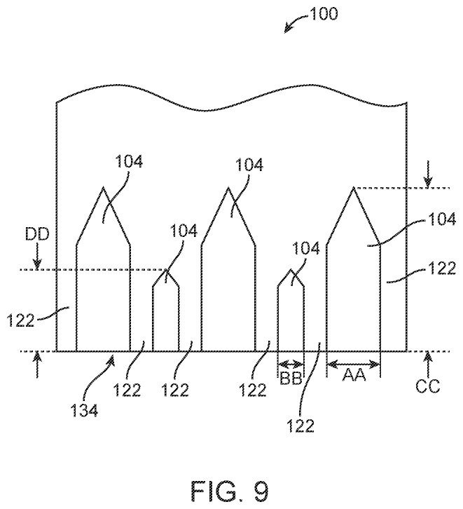

FIG. 9 is an illustration of medial end 134 of ear tip 100 including flutes 104 according to the present invention wherein flutes 104 have varying lengths and widths. In FIG. 9, dimension AA is the width of a wide flute 104 at medial end 134. In FIG. 9, dimension BB is the width of a narrow flute 104. In FIG. 9, dimension CC is the length of a long flute 104 measured from medial end 134. In FIG. 9, dimension DD is the length of a short flute 104 measured from the medial end 134 of flute 104.

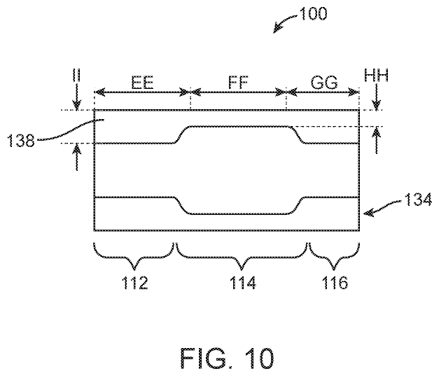

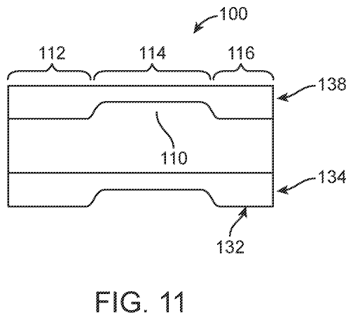

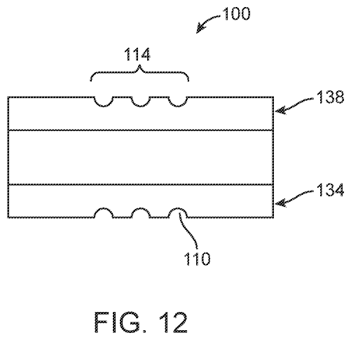

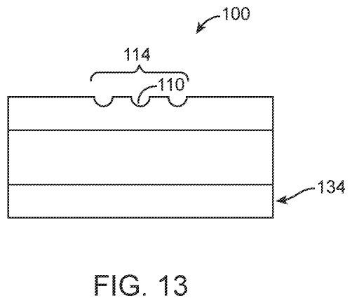

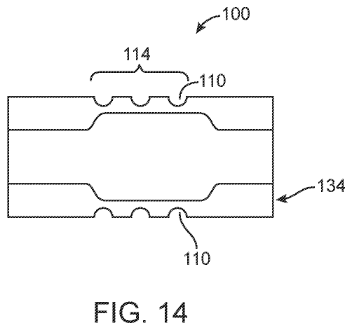

FIGS. 10-14 are side cut away views of an ear tip including a modified central region according to the present invention. In FIG. 10, dimension EE represents the length of lateral region 112, dimension FF represents the length of central region 114, and dimension GG represents the length of medial region 116. In FIG. 10, dimension HH represents the thickness of wall 138 of ear tip 100 at its thinnest while dimension II represents the thickness of wall 138 at its thickest. In the embodiment of FIG. 10, wall 138 is thinner in central region 114 than in lateral region 112 or medial region 116. In the embodiment of FIG. 11, wall 138 is thinner in central region 114 than in lateral region 112 or medial region 116. In the embodiment of FIG. 12, carve outs 110 are used to thin wall 138 in central region 114. In the embodiment of FIG. 13, carve outs 110 are used to thin portions of wall 138 in central region 114 on one side of ear tip 100. In the embodiment of FIG. 14, wall 138 is thinned and carve outs are included in central region 114. In embodiments of the invention, the features included in central region, including thinned portions of wall 138 and carve outs 110 may be referred to as stability features. In embodiments of the invention, stability features may be used to decouple movements of the lateral 112 and/or central 114 regions of light from movements of the medial 116 region of ear tip 100. When such movements are decoupled, movement of lateral 112 or central 114 regions will result in little or no movement of medial region 116, maintaining alignment between medial region 116 and components (not shown) positioned in the medial end of the ear canal (not shown).

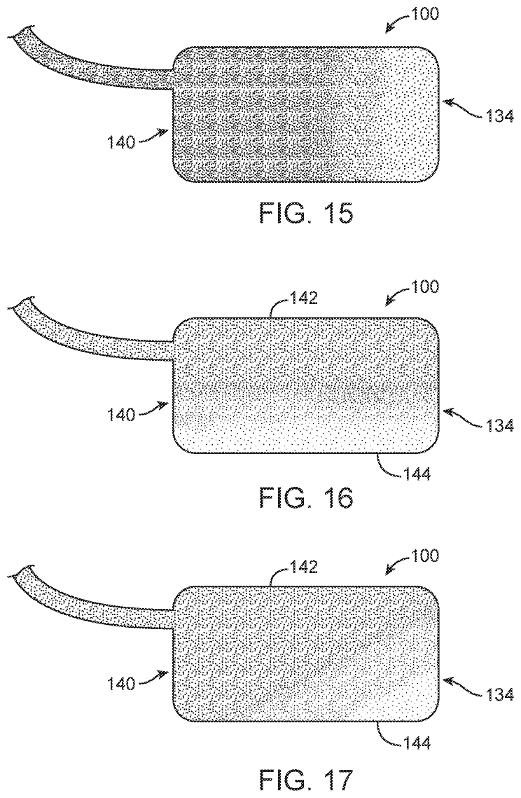

FIG. 15 is an illustration of ear tip 100 according to the present invention wherein ear tip 100 has a stiff lateral end 140 and a flexible medial end 134.

FIG. 16 is an illustration of ear tip 100 according to the present invention wherein ear tip 100 has a stiff superior edge 142 and a flexible inferior edge 144.

FIG. 17 is an illustration of an ear tip according to the present invention wherein ear tip 100 has a diagonal rigidity transition.

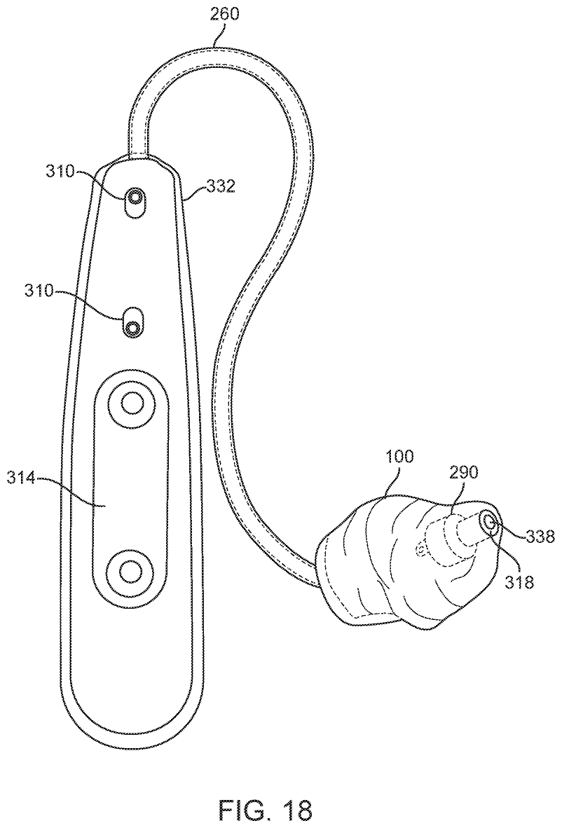

FIG. 18 illustrates an audio processor 332 and ear tip 100 according to the present invention. Ear tip 100 may, in some embodiments of the invention, be referred to as a mag tip or magnetic tip. In the embodiment of FIG. 7, audio processor 332 may include external microphones 310 and volume/control switch 314. In embodiments of the invention ear tip 120 may include a transmit coil 290 which may include ferrite core 318. In embodiments of the invention ear tip 120 may include an acoustic vent 338 which may pass through transmit coil 132 and/or through ferrite core 318. In embodiments of the invention ear tip 100 may include one or more of the features described herein with respect to the other Figures.

A structure designed to be placed into and reside in the ear canal of a user, where the structure is adapted to receive signals from an audio processor and transmit signals to the user's tympanic membrane or to a device positioned on or near the user's tympanic membrane (such as, for example, a contact hearing device). In one embodiment of the invention, the signals may be transmitted by light, using, for example, a laser positioned in the light tip. In one embodiment of the invention, the signals may be transmitted using radio frequency, using, for example, an antenna connected to the Ear Tip. In one embodiment of the invention the signal may be transmitted using inductive coupling, using, for example, a coil connected to the ear tip. The ear tip may also be referred to as a light tip, magnetic tip or mag tip.

In embodiments of the invention, the ear tip may be a structure designed to be placed into and reside in the ear canal of a user, where the structure is adapted to receive signals from an audio processor and transmit signals to the user's tympanic membrane or to a device positioned on or near the user's tympanic membrane (such as, for example, a contact hearing device). In one embodiment of the invention, the signals may be transmitted by light, using, for example, a laser positioned in the light tip. In one embodiment of the invention, the signals may be transmitted using radio frequency, using, for example, an antenna connected to the Ear Tip. In one embodiment of the invention, the signal may be transmitted using inductive coupling, using, for example, a coil connected to the ear tip. The ear tip may also be referred to as a light tip, magnetic tip or mag tip.

Features which may be included in ear tips to improve their performance include an ear tip having a variable hardness from the medial to the lateral end of the ear tip. As an example, the medial end of the ear tip may be manufactured from a low durometer (soft) material and the lateral end of the ear tip may be manufactured from a higher durometer (harder) material.

The soft material at the medial end of the ear tip prevents the medial end of the ear tip from damaging or irritating the ear canal. The harder material at the lateral end of the ear tip makes it easier for the user to insert the ear tip into the ear. The change in durometer may come ⅓ to ½ the length of the ear tip. The ear tip may be manufactured out of a single material having multiple durometers or out of multiple materials, each material having a different durometer.

In embodiments of the invention, the rigidity varies with position on the Ear tip shell. In one embodiment, the shell rigidity would vary in the lateral-medial direction (e.g., more rigid toward the lateral end and less rigid toward the medial end). In another embodiment, the shell rigidity would vary circumferentially (e.g., more rigid toward the superior edge and less rigid toward the inferior edge). In embodiments of the invention, the ear tip may have a stiff lateral end and a flexible medial end. In embodiments of the invention, the ear tip may have a stiff superior edge and a flexible inferior edge. In embodiments of the invention, the ear tip may have a diagonal rigidity transition. In embodiments of the invention, the rigidity may be varied by combining materials of different durometers. In embodiments of the invention, the rigidity may be varied by tailoring the shell wall thickness. In embodiments of the invention, the shell wall thickness may be tailored either uniformly or by introducing grooves.

A further feature which may be included in an ear tip is the presence of carve outs (i.e., indentations in the outer surface of the ear tip). These carve outs may take the form of, for example, a half moon and may be used to, for example, collect cerumen as the ear tip is pushed into and removed from the ear canal of a user. Carve outs may also be used to, for example, weaken the surface of the ear tip in order to make it more flexible. Positioning and orientation of the carve outs will enhance their function either as cerumen collectors or flexibility aids.

Further features which may be included in an ear tip include engagement features such as anti-skid bumps. The size, number, and location of these engagement features may be selected to ensure that the ear tip stays in the patient's ear. Other characteristics of the engagement features which may be adapted to a particular patient or ear tip design include the diameter, height, geometry of arrangement, and pattern of placement. The engagement features are generally positioned on the lateral end (e.g., within the lateral feature Region) of the ear tip to engage the soft tissue at that end of the ear canal. They are generally not used at the medial end of the ear tip where the skin covering the boney canal is thinner and tight to the bone. These features can create a significant resistance to lateral migration.

Additional engagement features may include micro-protrusions (e.g., micro-bumps) included in the flutes to engage biological tissue (e.g., cerumen) and hold it in the flutes. This added texture will enhance the ability of the flutes to engage wax in the flutes and to hold it there as the ear tip moves around (for example, when it is removed from the patient's ear).

Further features which may be included in an ear tip include flutes. Flutes are generally positioned at the medial end of the ear tip. Flutes may be used to collect biological material, including cerumen. The flutes add flexibility to the medial end of the ear tip while the spines (between the flutes) provide stability as the ear tip is pushed into the ear canal. Flutes may also be used to hold a lubricant, such as mineral oil. The lubricant would be distributed along the ear canal as the ear tip is pushed into position. Putting oil on flutes spreads oil on skin and distributes over surface of ear canal.

Flutes may be designed to have specific sizes and arrangements. For example, long flutes may be interspersed with short flutes around the outer perimeter of the medial end of the ear tip. The long flutes may be, for example, 40% of the length of the ear tip. The short flutes may be, for example 30% of the length of the ear tip. Width may also be varied from flute to flute. In one example, the wide flutes, which may also correspond to the long flutes, are approximately 2 mm wide at the medial end of the flute. In this example, the narrow flutes, which may also correspond to the short flutes, may be approximately 1 MM wide at the medial end of the ear tip. The spine between flutes may be thicker at the lateral end of the spine than at the medial end. This thickness change creates a blunted nose and softer medial tip, enhancing comfort for the wearer. The flutes may be designed to have an accordion effect, collapsing the medial end of the ear tip as the ear tip is inserted into the ear canal and expanding once the ear tip is properly positioned.

Further features which may be included in an ear tip include flexibility features which enable portions of the ear tip to bend or move in response to the movement of elements of the patient's ear canal anatomy. By allowing certain elements of the ear tip to bend or move in response to movements in the patient's ear canal, the overall stability of the ear tip, particularly at the medial end, may be enhanced. In one example, the outer wall in the central region of the ear tip may be thinned either all around the circumference or in a predetermined region to allow the central region to move in response to movement of components of the ear canal anatomy without translating that movement to the medial end of the ear tip. In another example, the thinned portion may comprise the portion of the central region of the ear tip which is positioned against the anterior wall of the patient's ear canal when the ear tip is properly positioned in the ear canal. In another example, the posterior wall may be thickened opposite the thinned anterior wall. These features allow the ear tip to bend in response to movements of anatomical elements of the patient's ear canal.

In an example, the ear tip may be divided into three Regions. A retention feature Region comprising approximately ⅓ of the length of the ear tip and starting at the lateral end. A stability feature Region comprising approximately ⅓ of the length of the ear tip and being located in the center of the ear tip. A comfort feature Region comprising approximately ⅓ of the length of the ear tip may be located at the medial end of the ear tip.

While the preferred embodiments of the devices and methods have been described in reference to the environment in which they were developed, they are merely illustrative of the principles of the present inventive concepts. Modification or combinations of the above-described assemblies, other embodiments, configurations, and methods for carrying out the invention, and variations of aspects of the invention that are obvious to those of skill in the art are intended to be within the scope of the claims. In addition, where this application has listed the steps of a method or procedure in a specific order, it may be possible, or even expedient in certain circumstances, to change the order in which some steps are performed, and it is intended that the particular steps of the method or procedure claim set forth herebelow not be construed as being order-specific unless such order specificity is expressly stated in the claim.

REFERENCE NUMBERS

| Number | Element |
|---|---|
| AA | Width of Large Flute |
| BB | Width of Small Flute |
| CC | Depth of Large Flute |
| DD | Depth of Small Flute |
| EE | Length of Lateral Region |
| FF | Length of Central Region |
| GG | Length of Medial Region |
| HH | Thickness of Ear Tip Wall (thickest) |
| II | Thickness of Ear Tip Wall (thinnest) |
| 100 | Ear Tip |
| 102 | Engagement Features (Anti-Skid Bumps, scales) |
| 104 | Flutes |
| 106 | Medial End |
| 108 | Lateral End |
| 110 | Carve Out |
| 112 | Lateral Region/Retention Feature Region |
| 114 | Central Region/Stability Feature Region |
| 116 | Medial Region/Comfort Feature Region |
| 118 | Biological Material (Cerumen) |
| 120 | Micro-Protrusions (Micro Bumps) |
| 122 | Spine |
| 124 | Hollow Region |
| 126 | Ear Canal Wall |
| 128 | Ear Canal |
| 130 | Anterior Wall |
| 132 | Posterior Wall |
| 134 | Medial End |
| 136 | Leading Edge |
| 138 | Ear tip Wall |
| 140 | Lateral End |
| 142 | Superior Edge |
| 144 | Inferior Edge |
| 260 | Cable |
| 290 | Transmit Coil |
| 310 | External Microphone |
| 314 | Volume/Control Switch |
| 318 | Ferrite Core |
| 332 | Audio Processor |
| 338 | Acoustic Vent |

1. An ear tip for use as a component in a hearing device, the ear tip comprising:
a shell, the shell comprising:
an outer wall, an inner wall, a medial end, and a lateral end;
one or more regions, the regions comprising:
a lateral region, a central region and a medial region wherein the lateral region
comprises a retention feature region, the central region comprises a stability
feature region and the medial region comprises a comfort feature region;
one or more retention features, the retention features comprising:
one or more of bumps or anti-skid bumps, wherein the retention features are located in at least the lateral region;
one or more stability features, the stability features comprising:
one or more of a thin outer wall or grooves, wherein the stability features are located in at least the central region;
one or more comfort features, the comfort features comprising:
one or more flutes, wherein the comfort features are located in at least the medial region, the flutes further comprising:
one or more of micro protrusions or micro bumps; and
one or more of long flutes or short flutes, wherein long flutes are longer than the short flutes and have a length up to approximately 40% of the length of the ear tip and the short tips have length up to approximately 30% of the length of the ear tip;
one or more spines separating the comfort features, wherein the spines are thickest at the lateral end
a transmit coil positioned in the shell, wherein the transmit coil surrounds a ferrite core; and
an acoustic vent positioned in the shell.

2. An ear tip according to claim 1 wherein the hardness of the material comprising the ear tip varies along the length of the ear tip, the medial end of the ear tip being softer than the lateral end of the ear tip.

3. An ear tip according to claim 2 wherein the durometer of the material at the medial end of the ear tip is lower than the durometer of the material at the lateral end of the ear tip.

4. An ear tip according to claim 1 wherein the rigidity of the material comprising the ear tip varies along the length of the ear tip, the medial end of the ear tip being more rigid than the lateral end of the ear tip.

5. An ear tip according to claim 1 wherein the rigidity of the material comprising the ear tip varies along the width of the ear tip, the superior side of the ear tip being more rigid than the inferior side of the ear tip.

6. An ear tip for use as a component in a hearing device, the ear tip comprising:
a shell, the shell comprising:
one or more retention features;
one or more stability features;
one or more comfort features
a transmit coil positioned in the shell, wherein the transmit coil surrounds a ferrite core; and
an acoustic vent positioned in the shell.

7. An ear tip according to claim 6, the shell comprising:
an outer wall, an inner wall, a medial end, and a lateral end; and
one or more regions, the regions comprising a lateral region, a central region and a medial region.

8. An ear tip according to claim 7 wherein the lateral region comprises a retention feature region, the central region comprises a stability feature region and the medial region comprises a comfort feature region.

9. An ear tip according to claim 6, the retention features comprising one or more of bumps or anti-skid bumps.

10. An ear tip according to claim 9 wherein the retention features are located in at least a lateral region of the ear tip.

11. An ear tip according to claim 6, the stability features comprising one or more of a thin outer wall or grooves.

12. An ear tip according to claim 11 wherein the stability features are located in at least a central region of the ear tip.

13. An ear tip according to claim 6, the comfort features comprising one or more flutes.

14. An ear tip according to claim 13 wherein the comfort features are located in at least a medial region of the ear tip.

15. An ear tip according to claim 13, the flutes further comprising one or more of micro protrusions or micro bumps.

16. An ear tip according to claim 13 where in the flutes comprise one or more of long flutes or short flutes.

17. An ear tip according to claim 16, wherein long flutes are longer than the short flutes.

18. An ear tip according to claim 17 wherein the long flutes have a length up to approximately 40% of the length of the ear tip

19. An ear tip according to claim 17 wherein the short tips have length up to approximately 30% of the length of the ear tip.

20. An ear tip according to claim 13 wherein one or more spines separate the comfort features.

21. An ear tip according to claim 20 wherein the spines are thickest at the lateral end of the spines.

22. An ear tip according to claim 5 wherein the hardness of the material comprising the ear tip varies along the length of the ear tip, the medial end of the ear tip being softer than the lateral end of the ear tip.

23. An ear tip according to claim 7 wherein the durometer of the material at the medial end of the ear tip is lower than the durometer of the material at the lateral end of the ear tip.

24. An ear tip according to claim 6 wherein the rigidity of the material comprising the ear tip varies along the length of the ear tip, the medial end of the ear tip being more rigid than the lateral end of the ear tip.

25. An ear tip according to claim 6 wherein the rigidity of the material comprising the ear tip varies along the width of the ear tip, the superior side of the ear tip being more rigid than the inferior side of the ear tip.
